(19) United States
(12) Patent Application Publication
(10) Pub. No.: US 2014/0147580 A1
(43) Pub. Date: May 29, 2014

(54) METHOD OF MANUFACTURING A CABLE

(71) Applicant: Smartwater Technology Limited, Greater London (GB)

(72) Inventor: Michael Cleary, London (GB)

(73) Assignee: SMARTWATER TECHNOLOGY LIMITED, London (UK)

(21) Appl. No.: 13/639,097

(22) PCT Filed: Apr. 2, 2012
(86) PCT No.: PCT/GB12/50741

§ 371 Date: Jan. 8, 2013

(30) Foreign Application Priority Data
Apr. 4, 2011 (GB) 1105619.9

(51) Int. Cl. H01B 13/34; H01B 13/14; H01B 13/06

(52) U.S. Cl. CPC H01B 13/34; H01B 13/345; H01B 13/06; H01B 13/143
USPC 427/117

(57) ABSTRACT

A method for manufacturing a uniquely identifiable cable, comprising the steps of: providing one or more wires to be included in a cable; applying a marker system to said one or more wires; and coating the one or more wires having the marker thereon with an insulating layer to form the cable. A device capable of executing the method. A uniquely identifiable cable comprising a marker system formed by the method.

### FIELD OF THE INVENTION

The present invention relates to a method of manufacturing a cable. In particular, the present invention relates to a method of manufacturing a cable comprising a marker system capable of identifying the source of the cable.

### BACKGROUND TO THE INVENTION

Copper is used extensively in electrical cable due to its high conductivity and corrosion resistance. As it has a particularly high price, it is commonly the subject of theft. This problem is growing increasingly common with not only copper but has extended to all types of non-ferrous metals.

Non-ferrous metals, for example copper and aluminium, are often used in cabling, in rail networks and telecommunications. Accordingly, the theft of such metal items is particularly costly for the party suffering the loss, not only due to the high value of the materials involved but the ensuing loss due to disruption of business and infrastructure can be orders of magnitude higher. For example, the theft of electrical cable can not only cause massive disruption due to malfunction of the devices in which it was in use but these thefts can also put people at risk of serious injury.

There is therefore a need to prevent or at least reduce the level of such theft. A way of doing this is to provide a mark on the material which establishes proof of ownership. In this way theft can be established and charges brought against those in possession of items which could positively be identified as stolen.

In recent years, the use of marker systems has been particularly useful in preventing crime and for tracking and identifying the authenticity of items. Such marker systems, as have been developed by the applicant for many years, have found particular application in the fields of security and crime prevention/deterrence, for example as described in WO 93/07233, GB 2369078, GB 2410208 and GB 2413675, amongst others. Analysis of the surface onto which the marker system is placed or deployed can provide a reliable method of tracing or authenticating items, articles, goods, vehicles or persons.

An important feature of a marker system is its stability under varying conditions. These conditions can involve excesses due to weather or chemical assault and deliberate attempts to remove the marker from marked items. Additionally, where the stolen goods comprise cables, it is common that the cables will be subjected to heat to remove any non-metallic material therefrom, such as for example the insulating material that surrounds the metallic wire. When the insulating material is removed from the metal or metallic compound within, there is often no way of positively tracing the source of the goods.

Therefore, there is a need to deter this sort of theft by providing for a cable which is still identifiable when stolen.

### SUMMARY OF THE INVENTION

In a first aspect of the invention, there is provided a method for manufacturing a uniquely identifiable cable, comprising the steps of: providing one or more wires to be included in a cable; applying a marker system to said one or more wires; and coating the one or more wires with an insulating layer to form the cable.

In a further aspect of the invention, more than one marker systems may be applied to said one or more wires. In such a case, the unique fingerprint or marker system may be changed along the length of the one or more wires if so required. This is most easily accomplished by means of applying the marker system onto the one or more wires from a suitably sized reservoir, similarly by roller, brush or spraying methods of application. In this type of application the reservoirs containing the marker system may be changed periodically so that a different marker is applied.

Where multiple markers are being used along the length of the one or more wires then smaller reservoirs may be held in suitable racks so that the rack not currently in use is accessible and may be changed.

In one embodiment, the method comprises providing a plurality of wires. In this embodiment, the wires may be entwined to form a wire assembly. The marker system may be applied to the wires prior to or subsequent to the formation of the wire assembly.

In one embodiment of the invention, the method further comprises the step of annealing the wire assembly. The marker system may be applied to the wire prior to the step of annealing the wire assembly. Additionally or alternatively, the marker system may be applied after the step of annealing the wire assembly.

In one embodiment of the invention, the marker system comprises a suspension; this is particularly the case where a large volume of a single fingerprint is being used. Preferably, a reservoir containing the marker system may be provided. Preferably, the reservoir may be stirred continuously to prevent settlement. A roller may be used to agitate the liquid in the reservoir to prevent settlement.

In one embodiment of the invention, the marker system may be applied to the cable by for example a roller and/or optionally by drops and/or optionally by spray.

In a further embodiment of the invention, the insulation layer may comprise a plastic type material. Preferably, the insulation layer comprises for example polyvinyl chloride and/or optionally polyethylene.

Any suitable apparatus/device may be used to apply the insulation to the wire. In one embodiment of the invention a T-shaped extrusion head may be used to coat the wire assembly with the insulation layer. Preferably, the metal wire assembly runs through the straight section of the T-shaped extrusion head.

In one embodiment of the invention, the marker system comprises a matrix and an aqueous polymer emulsion to bind the marker system to the surface of the marked goods. Preferably, the polymer system may be water based to avoid the use of solvents, or may comprise other solutions or suspensions.

In one embodiment of the invention the marker system may further comprise a unique fingerprint capable of distinguishing one marker system from that of another and to identify the source of the item to which it is coupled. Preferably, the fingerprint is water based and comprises one or more trace materials. Preferably, the used trace materials are metal compounds. Preferably, the trace materials are assigned constant positions in a binary string or optionally are assigned to constant position in an octal string.

In one embodiment of the invention, the marker system further comprises an indicator material. Preferably, the indicator material may be overt and can be seen unaided by technology. Preferably, the indicator may be a dye and/or optionally a pigment. Additionally or alternatively, the indicator material may be covert and will remain hidden until subjected to a predefined stimulus. Additionally or alternatively, the indicator material may comprise both a covert and overt mark.

In one embodiment there is provided that the marker system may be heat resilient, such that the marker system is capable of acting as a marker by uniquely identifying the cable when subjected to high temperatures. Preferably, the marker system may be heat resilient when subjected to temperatures up to 800° C.

In a further embodiment of the invention there is provided a device capable of executing the method described herein. Preferably, the device may be a plug in separate unit and capable of use with a wide range of different types of cable manufacture.

In a further embodiment of the invention there is provided a uniquely identifiable cable comprising a marker system formed by the method described herein.

Various alterations and modifications may be made to the present invention without departing from the scope of the invention.

The invention will now be further described with reference to the following exemplary embodiment.

A cable generally comprises one single wire or two or more wires, metal filaments, which are intertwined to form a single wire assembly, or bare conductor assembly. The single assembly may be formed when the two or more wires are either braided, twisted or bonded together. Additionally, the cable may further comprise an insulating layer covering the wire assembly. The present invention provides for a cable comprising a marker system capable of uniquely identifying the cable.

Various marker systems are available and the exact physical conditions necessary to successfully apply the marker system to a cable may be dependent on the actual marker system applied. It is desirable for the marker system to be capable of withstanding the temperatures involved in the formation of cabling and additionally of withstanding the temperatures used to remove the insulation layer of the cable from the wire.

In one embodiment of the invention, the marker system may include a matrix and an aqueous polymer emulsion to bind the marker system to the surface of the wire assembly. The polymer system may be water based to avoid the use of solvents, or may comprise other solutions or suspensions. The polymer system acts as an adhesive to secure the marker system, or surface coating, to the goods being protected.

In one embodiment, the marker system comprises an aqueous solution or dispersion wherein the amount of liquid added has been kept to a minimum. Preferably, the water is provided in a sufficient amount so that the solution may be sprayed but which does not result in the solution dripping off the wire.

The marker system may further comprise a unique fingerprint capable of distinguishing one marker system from that of another and to identify the source of the item to which it is coupled.

The fingerprint may comprise a volatile aqueous medium, together with for example a DNA trace or one or more trace materials which can be varied in such a manner as to produce unique formulations. The combinations of trace materials may advantageously be varied by modelling the compositions on, for example, binary strings to produce large numbers of unique products. However, other suitable coding methodologies may also be utilised as appropriate. The term “trace materials” applies herein to materials used at a concentration which would not normally be present in the environment of use. The most commonly used trace materials are metal compounds.

Trace materials can advantageously therefore be combined in a way which gives good evidential value to law enforcement agencies, as each unique formulation may be allocated to a particular premises, location or person, and this information is stored in a central database which can be accessed by a law enforcement agency receiving the report of a laboratory analyzing the mixtures which are to be discussed.

The trace materials may be assigned constant positions in a binary string with their presence being given by a “1”, and their absence by a “0”. If, for example, one were to set a limit of thirty digits for the string, one could begin with combinations of two trace materials, and generate all combinations containing any two trace materials. One could then go to groups of three trace materials, and generate all combinations of any three trace materials. This could continue until the number of trace materials is equal to the number of digits in the string.

With a thirty digit string, the total number of unique combinations of trace materials is approximately one billion. However, it is possible to prepare an infinite number of mixtures having compositions based upon unique binary sequences, the composition of each being unique.

Binary strings are provided as exemplary of the manufacturing procedures which can be used. Octal strings may also be used. Decimal numbers and random number generation can be used to generate potential codes, although these will need to be checked and converted to binary or octal sequences prior to use.

The unique nature of each composition can be checked during Quality Control following manufacture. The composition can then be stored in a database, allocated to a premises, location, or person, and the ownership of goods located at a later time can be identified relating to the premises, location or person via the composition.

Of course, the greater the number of trace materials used, the greater the certainty in identification later on, since the chance presence of trace materials can be ruled out.

The marker system may further comprise an indicator material, which can quickly provide a preliminary, gross indication of the presence of a composition according to the invention. The indicator material can either be “overt” or “covert.” An overt material is typically one which can be seen unaided by technology, such as a dye or pigment. With an overt indicator, it is immediately evident from an observation of the article or person that a mark has been provide thereon which may act as a deterrent. In one embodiment both a covert and overt mark may be applied thus combining the deterrent effect of the overt mark with the covert properties of the covert mark. For example, if the overt mark failed to act as a deterrent and the perpetrator tried to remove the overt mark; even if they were successful the stolen item could nevertheless still be identified by virtue of the covert mark.

A covert indicator will remain hidden until some technical means or stimulus is used to make it obvious. Usually, a covert indicator will become visible upon application of a radiation source other than visible light, and of these, fluorescent indicators are most common. Thus, the covert indicator will often be at least one fluorescent material which is soluble in a solvent system, and which is easily detectable upon examination with ultraviolet light, for example.

It is possible to utilise a fluorescent material which when exposed to UV light fluoresces in a particular colour, each particular fluorescent material being selected for a particular customer, so that when the composition containing the selected fluorescent material is applied to a surface of articles or goods, then any unauthorised removal of such articles or goods can be linked back to the particular customer as the source of goods. It is further possible to utilise a combination of two or more fluorescent materials having differing X max emission wavelengths.

It is possible to identify said two or more materials by utilising a UV-absorption spectrum or a fluorescent emission spectrum of an indicator. Accordingly, such combination of materials, when applied to a surface of articles or goods, can also be used to link the particular goods to the customer. Alternatively or additionally, the indicator may comprise at least one phosphorescent material capable of phosphorescing when subjected to stimulus.

When the gross indicator means is fluorescent, the composition can include one or more of any suitable fluorescent materials. In terms of suitable indicators, both organic and inorganic materials may be used.

In one embodiment of the invention, the wire assembly may be subjected to heat treatment. By subjecting the wire assembly to heat treatment, or annealing, the one or more wires defining the wire assembly may be made homogeneous. This may advantageously relieve internal stresses and induce ductility of the wire assembly.

In one embodiment of the invention, the marker system may be applied to the wire assembly prior to any annealing that may be required. Additionally or alternatively, the marker system may be applied to the surface of the wire assembly post any annealing of the wire assembly.

Where the marker system is applied to a non-armoured cable, or cables, the marker system may be added directly to the wire assembly prior to the insulation layer being added. Where the marker system is applied to an armoured cable, the marker system may be applied directly to the wire assembly under the armoured layer. Additionally or alternatively, where the marker system is applied to an armoured cable, the marker system may be applied to the outer surface of the armoured layer.

In one embodiment, the marker system may be applied to the surface of the wire assembly. Several methods of application may be used to apply the marker system in respect of a cable. In one preferred embodiment, the marker system may be applied to the surface of the wire assembly drop wise. Alternatively or additionally, the marker system may be applied to the surface in a spray form or from a roller.

In one embodiment of the invention, the marker system may be provided in the form of a suspension. A reservoir containing the marker system may be provided.

Preferably, the reservoir may be stirred continuously to avoid settlement. Additionally or alternatively, the marker system may be held in a stirred reservoir to avoid settlement.

In one embodiment of the invention, the marker system may be applied to the wire assembly by a roller. Where a roller is used, the action of the roller in the suspension of the marker system may provide sufficient movement to prevent settlement. Advantageously, this use of a roller may negate the need for a stirred reservoir.

In an alternative embodiment, it is provided that the marker system may be applied by spraying. Additionally or alternatively, the reservoir of marker system may be placed above the cable and be allowed to simply drop onto the surface being applied with the marker system.

In a further embodiment of the invention, the wire assembly is coated or jacketed with an insulation layer such that the insulation layer provides a jacket to the marker system provided on the bare conductor wire assembly. In a preferred embodiment of the invention, the insulation layer may comprise plastic; for example, polyvinyl chloride or polyethylene, or a combination thereof. Various methods of extrusion may be used to form the insulation layer.

In one embodiment of the invention, the marker system may be changed along the length of the wire. Marking the length of the cable with one fingerprint allows that length of cable to be identified. However, if that length of cable is sold to different customers then it is harder to prove the ownership of the cable and therefore it is often more difficult to successfully bring theft charges. Usually in such cases, it will be easy to identify the manufacturer of the cable but it may be more onerous to identify the owner of the cable.

However, if the fingerprint in the marker is changed along the length of the cable at a length to suit then specific identification can be made. This process would be further improved where the cable manufacturer kept records of customers to whom each length of cable was sold.

The temperatures of the extrusion process will vary with the nature of the type of polymer used to form the insulation layer. In one embodiment it is provided that the temperature of the extrusion process will not exceed 200° C. For example, when pvc is used the temperature is generally about 180° C., In one embodiment of the invention, a marker system is provided which is heat resilient, or temperature resistant, to temperatures up to 200° C. Additionally or alternatively, each of the components of the marker system may be heat resilient, or temperature resistant, to temperatures up to 200° C.; for example, the fingerprint and/or optionally the indicator.

In one embodiment of the invention, a T-shaped extrusion head may be used, wherein the metal runs through the straight section of the T-shaped extrusion head. The molten plastic may then be fed to the metal. When the plastic subsequently cools, it may form a continuous layer around both the conductor and the marker.

Further, the present invention describes a unit for the application of marker that is a plug in separate unit and capable of use with a wide range of different types of cable manufacture.

A number of embodiments have been described herein. However, it will be understood by persons skilled in the art that other variants and modifications may be made without departing from the scope of the embodiments as defined in the claims appended hereto.

1. A method for manufacturing a uniquely identifiable cable, comprising the steps of:
providing one or more wires to be included in a cable;
applying a marker system to said one or more wires; and
coating the one or more wires having the marker thereon with an insulating layer to form the cable.

2. The method of claim 1, wherein more than one marker system is applied so that different markers are on different lengths of the said one or more wires.

3. The method of claim 2, wherein the marker systems are applied consecutively on the one or more wires.

4. The method of claim 1, wherein a plurality of wires are provided for inclusion in said cable and which plurality of wires are entwined to form a wire assembly, the marker system being applied to the wires prior to or after the formation of said wire assembly.

5. The method of claim 4, wherein the marker system is applied to the wires prior to or after the step of annealing the wire assembly.

6. The method of claim 1, wherein the marker system comprises a suspension.

7. The method of claim 6, wherein a suspension is used in cases where a single marker system is applied to the one or more wires or optionally where a single marker system is applied to a substantial length of the one or more wire.

8. The method of claim 6, wherein a reservoir containing the marker system is provided.

9. The method of claim 8, wherein the reservoir is stirred to avoid settlement in the suspension.

10. The method of claim 9, wherein a roller may be used to stir the reservoir to prevent settlement in the suspension.

11. The method of claim 10, wherein the reservoir is a stirred reservoir to prevent settlement in the suspension.

12. The method of claim 8, wherein the size of the reservoir is varied dependent on the amount of marker system to be applied to the one or more cables.

13. The method of claim 8, wherein one or more racks are provided.

14. The method of claim 13, wherein the one or more racks are configured to receive and hold one or more reservoirs, such that the one or more racks provide storage when the one or more reservoirs are not in use.

15. The method of claim 1, wherein the marker system is applied to the cable by roller.

16. The method of claim 1, wherein the marker system is applied to the cable by brushing.

17. The method of claim 1, wherein the marker system is applied to the cable by drops.

18. The method of claim 1, wherein the marker system is applied to the cable by spray.

19. The method of claim 1, wherein the insulation layer comprises a plastic type material.

20. The method of claim 19, wherein the insulation layer comprises polyvinyl chloride.

21. The method of claim 19, wherein the insulation layer comprises polyethylene.

22. The method of claim 1, wherein a T-shaped extrusion head is used to coat the wire assembly with the insulation layer.

23. The method of claim 22, wherein the metal runs through the straight section of the T-shaped extrusion head.

24. The method of claim 1, wherein the marker system comprises a matrix and an aqueous polymer emulsion to bind the marker system to the surface of the marked goods.

25. The method of claim 24, wherein the polymer system is water based.

26. The method of claim 1, wherein the marker system further comprises a unique fingerprint capable of distinguishing one marker system from that of another and to identify the source of the item to which it is coupled.

27. The method of claim 26, wherein the fingerprint comprises a solvent medium and one or more trace materials.

28. The method of claim 27, wherein the trace materials comprise metal compounds or unique sequences of nucleic acids.

29. The method of claim 27, wherein the trace materials are assigned constant positions in a binary string.

30. The method of claim 27, wherein the trace materials are assigned to constant position in an octal string.

31. The method of claim 1, wherein the marker system further comprises an indicator material.

32. The method of claim 31, wherein the indicator material is overt and can be seen unaided by technology.

33. The method of claim 32, wherein the indicator is a dye and/or optionally a pigment.

34. The method of claim 31, wherein the indicator material is covert and will remain hidden until subjected to a predefined stimulus.

35. The method of claim 31, wherein indicator material is both a covert and overt mark.

36. The method of claim 1, wherein the marker system is heat resilient, such that the marker system is capable of withstanding high temperatures.

37. The method of claim 36, wherein the marker system is heat resilient when subjected to temperatures up to 200° C.

38. (canceled)

39. (canceled)

40. (canceled)
